(19) United States
(12) Patent Application Publication
(10) Pub. No.: US 2008/0083305 A1
(43) Pub. Date: Apr. 10, 2008

(54) WRENCH

(76) Inventor: JIMMY MILEY, Breckenridge, TX (US)

Correspondence Address: MICHAEL RIES, 318 PARKER PLACE, OSWEGO, IL, 60543, US

(21) Appl. No.: 11/866,389

(22) Filed: Oct. 2, 2007

Related U.S. Application Data
(60) Provisional application No. 60/828,123, filed on Oct. 4, 2006.

(51) Int. Cl. B25F 1/00; B25B 13/08

(52) U.S. Cl. 81/437; 81/119

(57) ABSTRACT

The present invention is a wrench for tightening or removing caps on containers. More specifically a wrench to tighten or remove a tote cover or bung. Disclosed is a combination tote cover and bung wrench. Also disclosed is just a tote cover wrench.

This application claims priority to U.S. Provisional Application 60/828,123 filed 10-04-2006, the entire disclosure of which is incorporated by reference.

### TECHNICAL FIELD & BACKGROUND

The present invention generally relates to the field of tools to loosen and tighten caps from containers. More specifically, the present invention relates to a wrench to open or close lids on intermediate bulk containers (IBC) totes or bungs.

More often than not, workers are unable to quickly and efficiently open or close lids on Intermediate Bulk Containers totes. It is also difficult to torque the lids down for transport per Department of Transportation (DOT) safety regulations. Currently, frustrated workers rely on the inefficient and dangerous method of beating on the lids with a hammer, often causing damage to either a persons hands or the approximately $18 apiece tote lids. In addition, some chemicals cause the lids to stick and the sun's heat can melt plastic lids, welding them shut.

The present invention is a combination tote and bung wrench that aids in opening and closing the lids on Intermediate Bulk Containers totes as well as torque these lids to the Department of Transportation regulatory psi standards for safety in transportation. This device will also open and close 1.9 inch or 2 inch bungs on metal or plastic 55 gallon drums.

The present invention is a tool that is used to easily open close and torque down IBC Totes as well as open bungs on plastic or metal 55-gallon drums. The present invention may be constructed from rectangular 14 gauge tubing that measures 1″ by 2″, the wrench may be available in three options: combination, which measures 18″ long, Heavy Duty or Oil Field grade, made with 3/16″ thick material which also measures 18″ long and features the bung wrench to open and close bungs on 55-gallon drums, and Large IBC Triwall, which measures 30″ in length for use on larger totes. The Combination Quick Tote Wrench has two ⅛ channel irons that measure 2.5″ by 0.2″, while the Heavy Duty and Large IBC wrench have two channel irons that measure 0.125″ thick by 2.5″ long, by 1″ wide. While they can be constructed to fit varying sized caps, currently the C channels on the Combination and Heavy Duty models are centered to fit an 8″ cap and welded to the unit. On the Heavy Duty Quick Tote Wrench; the ends of the two channels are milled to fit the bungs on totes and 55 gallon drums. All options utilize a 0.5″ bolt with a 0.75″ hexagonal head for ease when torquing tote lids to meet DOT standards and have a 2.25″ stainless steel key ring attachment.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a wrench, in accordance with one embodiment of the present invention;

FIG. 2 illustrates a drawing of a side view of a wrench, in accordance with one embodiment of the present invention;

FIG. 2a illustrates a drawing of a side view of a wrench, in accordance with one embodiment of the present invention;

FIG. 2b illustrates a drawing of two end views of a wrench, in accordance with one embodiment of the present invention;

FIG. 2c illustrates a drawing of a top view of a wrench, in accordance with one embodiment of the present invention;

FIG. 3 illustrates a drawing of a wrench, in accordance with one embodiment of the present invention;

FIG. 4 illustrates a drawing of a wrench, in accordance with one embodiment of the present invention;

FIG. 5 illustrates a drawing of a wrench, in accordance with one embodiment of the present invention;

FIG. 6 illustrates a drawing of a wrench, in accordance with one embodiment of the present invention; and

FIG. 7 illustrates a drawing of a wrench, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

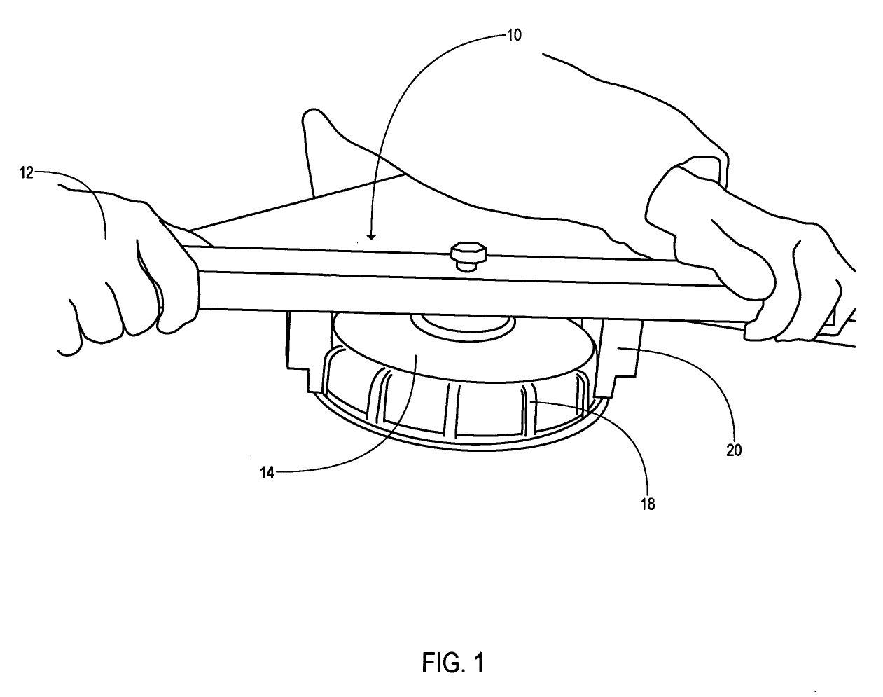

Referring now to FIG. 1, illustrated is a wrench 10 with a user 12 applying the wrench 10 to a tote cover 14. Tote cover 14 has a plurality of ridges 18 that come into contact with at least one channel iron 20. Wrench 10 may have two channel irons 20 that are positioned to accept the tote cover 14 in between. The user 12 will apply either a clockwise or counter clockwise force to the wrench 10 to open and remove tote cover 14 or to tighten down tote cover 14. Channel iron 20 will come into contact with the ridge 18.

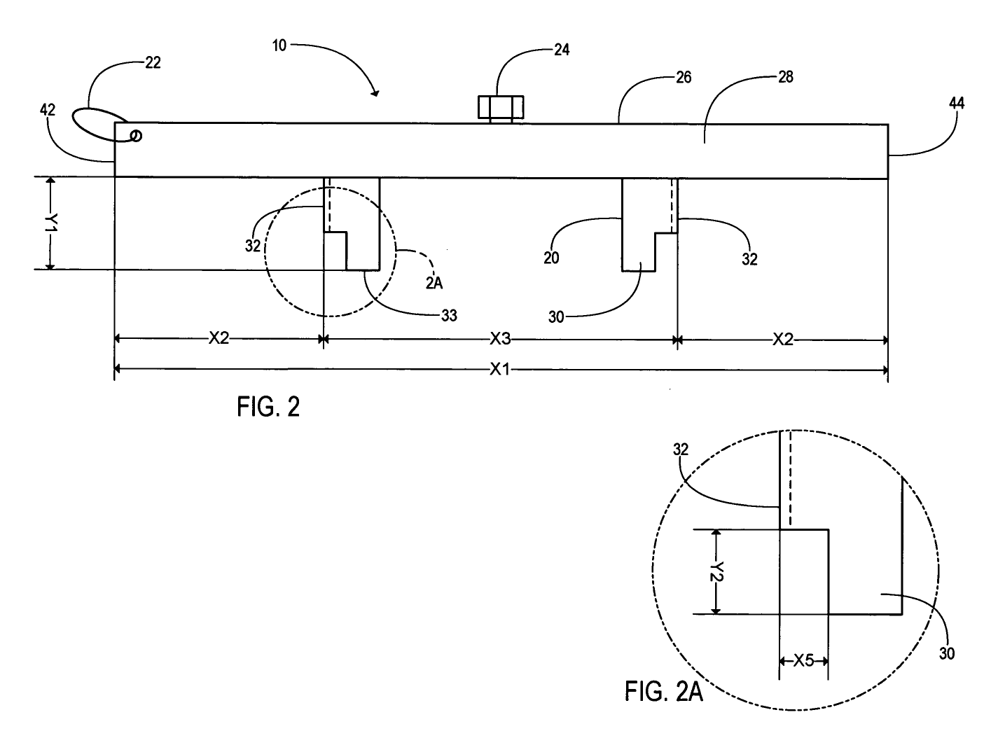

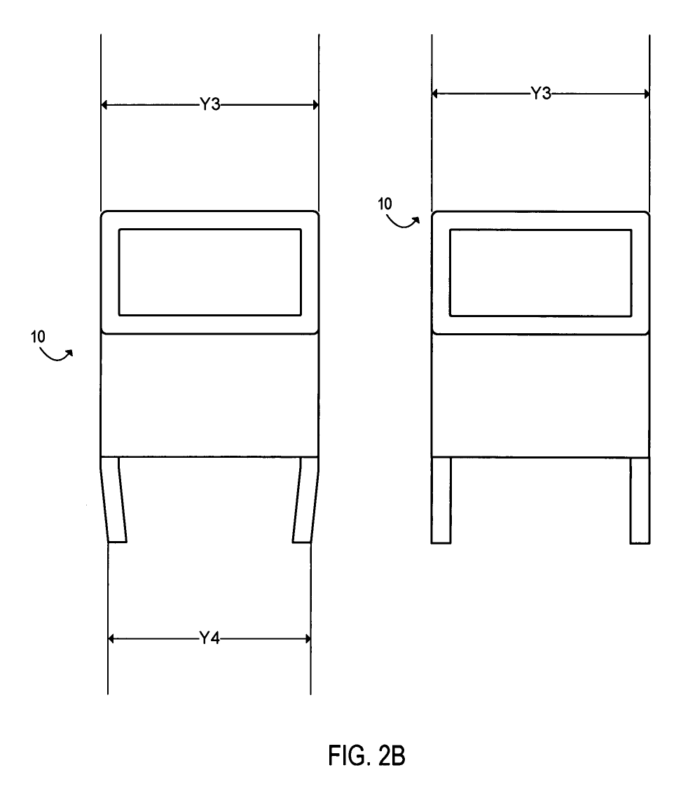

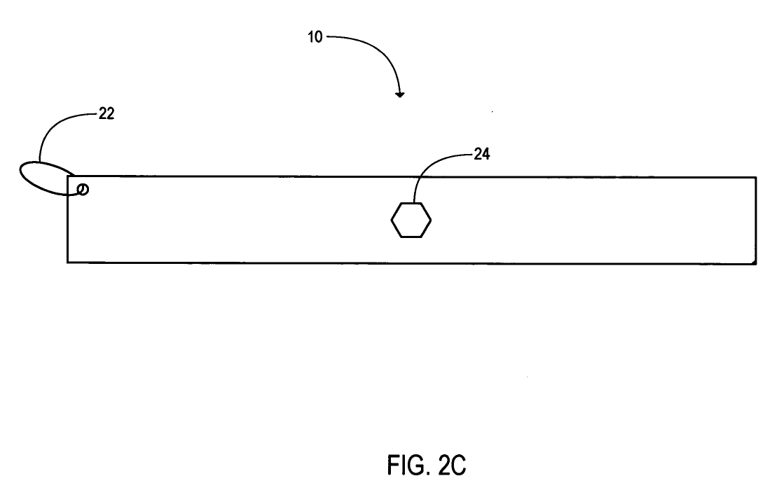

Referring to FIGS. 2 and 2a, illustrated is a side view of one embodiment of the wrench 10. Shown is a key ring 22 that may be made out of stainless seal. A hex head 24 is connected to the top surface 26 of a main body 28 of wrench 10 and located at a center point of the wrench 10. The Hex head 24 is used to toque tote cover 14 to a specified torque requirement. Hex head 24 may be 0.75 inch hex stock or a bolt. The channel iron 20 has a first channel iron tab 30 and a second channel iron tab 33 that extends from a channel iron back 32. The first channel iron tab 30 may extend a channel iron tab distance Y2 from a channel iron back 32 and offset an channel iron tab offset distance X5. The channel iron tab distance Y2 may be 0.625 inch and the channel iron tab offset distance X5 may be 0.375 inch.

In FIGS. 2 and 2a, as in one embodiment the channel iron 20 has a channel iron length Y1 that may be 2.125 inches. The main body 28 has a main body length X1 that may be 18 inches. The wrench 10 has a first wrench end 42 and a second wrench end 44. The channel iron 20 is positioned a wrench end distance X2 from either the first wrench end 42 and the second wrench end 44 that may be 4.75 inches. Channel irons 20 are a channel iron separation distance X3 that may be 8.5 inches. In FIG. 2b, as in one embodiment shown is an end view of wrench 10. Shown is a main body width Y3 that may be 2 inches and channel iron width Y4 that may be 1.9 inches or 2 inches. In FIG. 2b the left drawing shows channel irons 20 tapering into each other and the right drawing showing no taper. In FIG. 2c, as in one embodiment shown is a top view of wrench 10. Shown is key ring 22 and hex head 24.

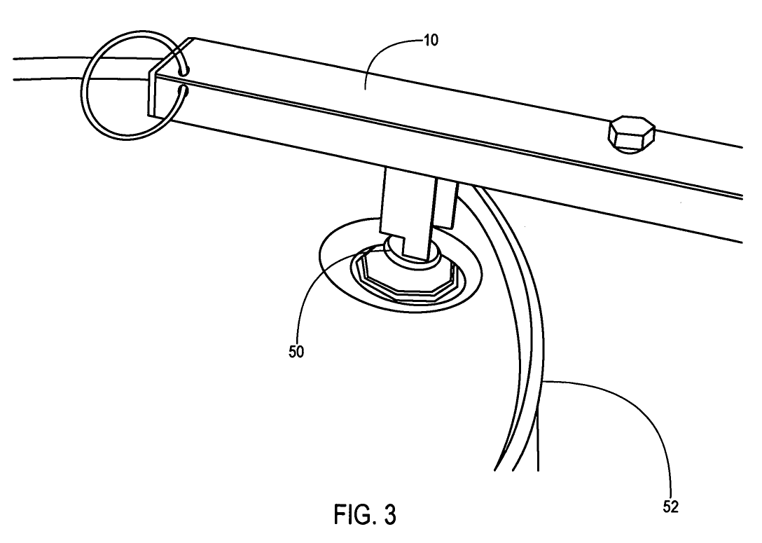

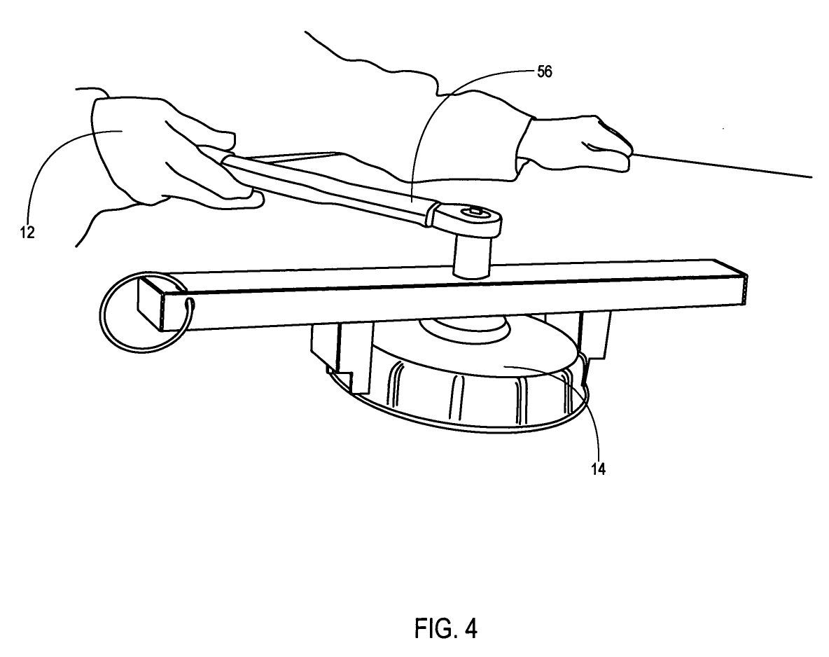

In FIG. 3, as in one embodiment the wrench 10 is used to open or close a bung 50, the bung 50 may be used to seal a fifty five gallon barrel 52. Channel iron 20 is inserted inside bung 50. In FIG. 4, as in one embodiment the wrench 10 has torque wrench 56 connected to hex stock 24. This will allow user 12 to tighten the tote cover 14 or the bung 50 to a specific torque value.

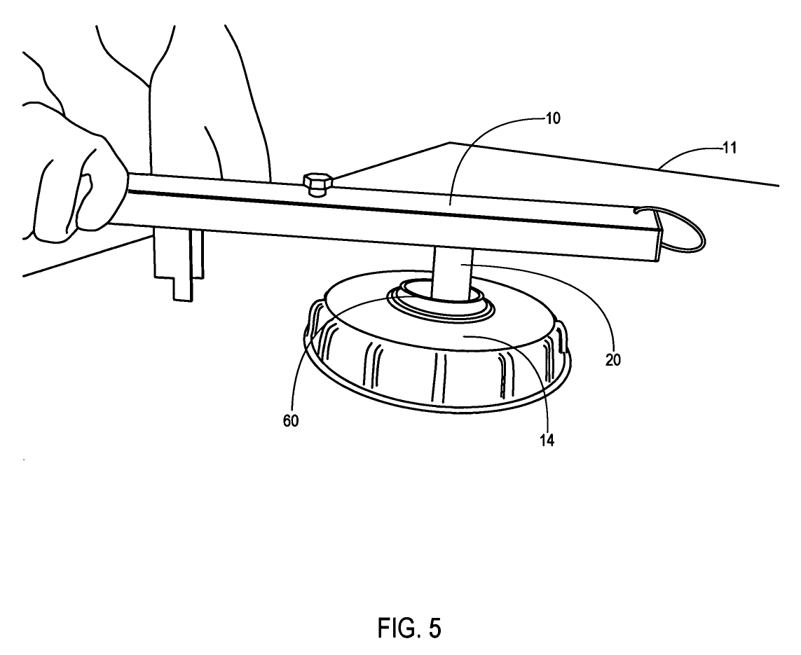

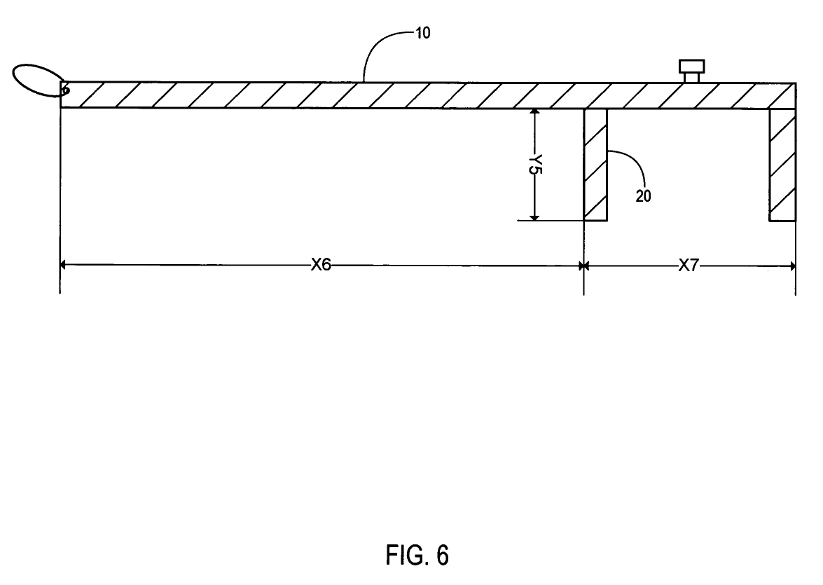

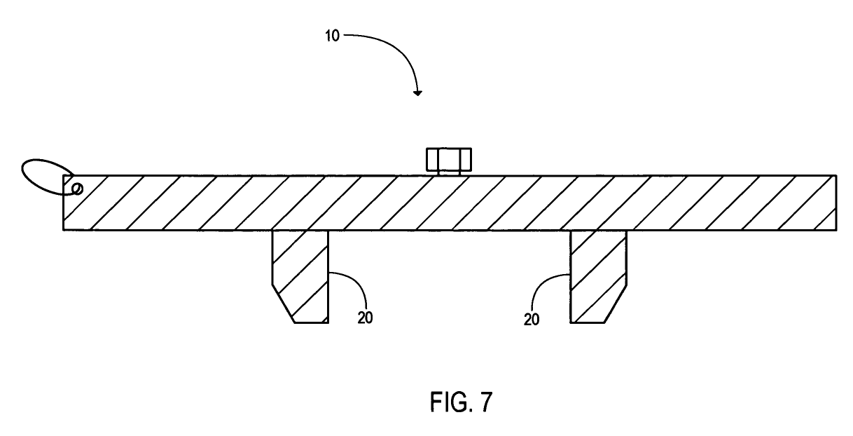

In FIG. 5, as in one embodiment the tote cover 14 may have a center internal lug 60 that accepts the channel iron 20. The center internal lug 60 provides another way to use wrench 10 to open and close a tote 11. In FIG. 6, as in one embodiment the wrench 10 has channel irons 20 moved to one end of the wrench 10. Shown are an offset distance X6 that may be 19.375 inches and offset channel iron distance X7 that may be 10.625 inches. Offset channel iron length Y5 may be 6 inches. In FIG. 7, as in one embodiment the wrench 10 has channel irons 20 without the first channel iron tab 30 and a second channel iron tab 33 this will allow for heavy duty applications or for standard applications to use on tote covers and not on bungs.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A device comprising:
a wrench with a main body having a top and bottom surface, two channel irons are connected to the bottom surface, the two channel irons are shaped and configured to accept a cover, a hex socket is connected to the top surface.

2. The device of claim 1, wherein the channel irons have a at least one tab on each end to fit into a bung for a 55 gallon drum.

3. The device of claim 1, wherein the channel irons have a at least one tab on each end to fit into a center lug on the cover.

4. The device of claim 1, wherein a key ring is attached to the main body.

5. The device of claim 1, wherein the hex socket is from a selected one of hex stock and a hex bolt.

6. The device of claim 1 wherein the cover is a tote cover.

7. The device of claim 1, wherein the channel irons have a pair of tabs on each end.

8. A device comprising:
a wrench with a main body having a top and bottom surface, two channel irons are connected to the bottom surface, the two channel irons have a pair of tabs on each channel iron, the pair of tabs are a selected one of straight in shape and tapered into each other, a hex socket is connected to the top surface.

9. A method comprising:
placing two channel irons over a tote cover, the channel irons contacting the tote cover, the two channels connected to a wrench;
holding a main body with both hands of a user, the main body connected to the two channel irons, the main body is the backbone of the wrench;
applying a clockwise or counterclockwise force by the user with both hands to the wrench; and
removing or tightening the tote cover by the applied force.

10. The method of claim 9, wherein the channel irons have a at least one tab on each end to fit into a bung for a 55 gallon drum.

11. The method of claim 9, wherein the channel irons have a at least one tab on each end to fit into a center lug on the cover.

12. The method of claim 9, wherein a key ring is attached to the main body.

13. The method of claim 9, wherein the hex socket is from a selected one of hex stock and a hex bolt.

14. The method of claim 9 wherein the cover is a tote cover.

15. The method of claim 9, wherein the channel irons have a pair of tabs on each end.
